(19) United States
(12) Patent Application Publication
(10) Pub. No.: US 2025/0263316 A1
(43) Pub. Date: Aug. 21, 2025

(54) FLUORIDE CAPTURE FROM WASTEWATER

(71) Applicant: HULICO LLC, Bend, OR (US)

(72) Inventors: Steven E. Sloop, Bend, OR (US); Meilani Bolding, Bend, OR (US)

(21) Appl. No.: 19/060,170

(22) Filed: Feb. 21, 2025

Related U.S. Application Data
(60) Provisional application No. 63/556,336, filed on Feb. 21, 2024.

(51) Int. Cl. C02F 1/52; C02F 1/66; C02F 101/14; C02F 103/34

(52) U.S. Cl. CPC C02F 1/5236; C02F 1/66; C02F 2101/14; C02F 2103/34

(57) ABSTRACT

One example provides a method of recovering fluoride from wastewater with a first, higher concentration of fluoride. The method comprises adding a metal cation to the wastewater that reacts with fluoride in the wastewater to form a precipitate comprising a fluoride compound that is less soluble in water than lithium fluoride to produce treated wastewater with a second, lower concentration of fluoride; and recovering the precipitate.

### CROSS-REFERENCE TO RELATED APPLICATION

This application claims priority to U.S. Provisional Application No. 63/556,336 entitled FLUORIDE CAPTURE FROM WASTEWATER, filed Feb. 21, 2024, the entire contents of which are hereby incorporated by reference for all purposes.

### BACKGROUND

Rechargeable batteries, such as lithium-ion batteries, provide power to products ranging from automobiles to smart phones. These batteries may be rechargeable over many cycles, tolerant to various environmental factors, and have a relatively long useful lifetime. Nevertheless, they eventually fail or are discarded prior to failure, and therefore contribute to a significant waste stream. Thus, environmental regulations, industry standards, and collection services have arisen to promote the recycling of lithium-ion batteries.

### SUMMARY

Examples are disclosed that relate to recovering fluoride from wastewater, such as wastewater from a battery recycling process.

One example provides a method of recovering fluoride from wastewater with a first, higher concentration of fluoride. The method comprises adding a metal cation to the wastewater that reacts with fluoride in the wastewater to form a precipitate comprising a fluoride compound that is less soluble in water than lithium fluoride to produce treated wastewater with a second, lower concentration of fluoride; and recovering the precipitate.

### BRIEF DESCRIPTION OF THE DRAWINGS

FIG. 1 schematically shows a process in which capture of fluoride from lithium fluoride-containing wastewater is used to recover useable fluoride and also treat the wastewater for reuse.

FIG. 2 shows a flow diagram depicting an example method of recovering fluoride from wastewater generated in a battery recycling process.

FIG. 3 schematically shows a system for recovering fluoride from fluoride-containing wastewater generated in a battery recycling process.

FIG. 4 shows a two-theta powder x-ray diffraction scan of calcium fluoride recovered from an experimental lithium fluoride solution into which calcium hydroxide was mixed at a temperature of 100 degrees Celsius.

FIG. 5 shows a two-theta powder x-ray diffraction scan of calcium fluoride recovered from an experimental lithium fluoride solution into which calcium hydroxide was mixed at a temperature of 100 degrees Celsius.

FIG. 6 shows a 2-theta powder x-ray diffraction scan of calcium fluoride recovered from fluoride-containing wastewater from a battery recycling process by adding calcium hydroxide to the wastewater at a temperature of 50 degrees Celsius.

### DETAILED DESCRIPTION

Various components of lithium ion batteries, and potentially other batteries and recyclable devices, include fluorine-containing compounds. For example, a lithium ion battery can utilize a fluoride-containing salt, such as a lithium hexafluorophosphate salt, as an electrolyte component. Also, a lithium ion battery can utilize a fluorine-containing polymer, such as polyvinylidene fluoride (PVDF), as a binder.

Lithium ion battery recycling can involve various mechanical and chemical processes performed in an aqueous media. For example, a binder decomposition step can be used to decompose a binder used to bind battery electrode materials to current collectors. Decomposition of the binder can produce wastewater containing aqueous fluoride species. Likewise, discharge, opening, and rinse steps can be used prior to binder decomposition to recover the electrode/current collector/separator assemblies, and to separate the electrode/current collector structures from the separator. Such processes also can produce wastewater comprising aqueous fluoride species. Additionally, hydrothermal processing can be used to replenish lithium ions in a depleted cathode material. The hydrothermal processing can be followed by an additional washing step. This additional washing step can produce additional wastewater comprising aqueous fluoride species.

Accordingly, examples are disclosed that relate to recovering fluoride from wastewater, such as wastewater produced in a battery recycling process. The fluoride in the wastewater may, for example, take the form of lithium fluoride, among other species. Briefly, the disclosed examples recover fluoride by mixing a salt comprising a cation that can react with fluoride to form a relatively insoluble fluoride compound. The term “relatively insoluble” generally refers to a compound with a lower solubility in water than lithium fluoride. As one example, a calcium salt, such as calcium hydroxide, can be introduced to form calcium fluoride according to the following reactions.

2LiF(s)←→2Li+(aq)+2F−(aq) (1)

2Li+(aq)+2F−(aq)+Ca(OH)2(s)→CaF2(s)+2Li+(aq)+OH−(aq) (2)

Calcium fluoride is less soluble in water than calcium hydroxide. As such, the calcium fluoride can precipitate from the solution, allowing recovery of the fluoride. The use of calcium hydroxide instead of other calcium salts has the advantage that the hydroxide ion is not a contaminant that can impact battery performance. As such, calcium hydroxide can be used without impacting the ability to use the wastewater in another battery recycling process. This allows the wastewater to be reused in battery recycling. In other examples, other calcium compounds, such as calcium chloride, can be used, although additional purification to remove the anion (e.g. chloride) may be performed before the wastewater can be reused in a battery recycling process. Other example calcium compounds can include calcium carbonate and calcium oxide.

Calcium fluoride is a precursor for industrial hydrogen fluoride. Thus, calcium fluoride recovered as a precipitate from the wastewater can be used to generate hydrogen fluoride, which can be then used for other processes.

When reusing the wastewater in another recycling process after recovery of the fluoride from the wastewater, the hydroxide ion in the wastewater from the calcium hydroxide can provide an additional advantage. When recycling lithium nickel manganese cobalt oxide cathodes, it can be beneficial to use alkaline solutions to rinse the battery and decompose the binder, as the alkaline solution helps maintain nickel in a desired oxidation state. Thus, the hydroxide from the calcium hydroxide fluoride removal step helps to provide an alkaline solution for such rinsing and decomposition steps. In some such examples, an additional base other than a hydroxide base can be added to the rinse and/or binder decomposition solutions. As an example, alkylammonium bases, such as tetrabutylammonium hydroxide (TBAOH), can be used. TBAOH is an organic base. Thus, any residual TBAOH that is left in a battery electrode material after lithium replenishment can be removed by sintering, calcining, annealing, and/or otherwise heating the battery material after lithium replenishment.

Further, lithium hydroxide that remains in the wastewater after reaction of calcium hydroxide with fluoride can be used in the hydrothermal regeneration of battery active material (e.g. cathode active material) in a battery recycling process. Such a process can involve exposing a cathode material (e.g. lithium nickel manganese cobalt oxide) to lithium hydroxide under elevated pressure and temperature. Thus, after fluoride removal, the lithium hydroxide-containing wastewater may be well-suited for use again in battery recycling.

In some examples, formation of calcium fluoride can be facilitated by reducing a pH of the wastewater. For example, lithium replenishment can be performed using hydrothermal processing in the presence of lithium hydroxide. The pH of the solution can be above 13. The high pH can impede the formation of calcium fluoride. Thus, an acid can be added to reduce the pH to 13 or lower to facilitate calcium fluoride formation. In some examples, the pH can be reduced to a value of between 5 and 10. In some such examples, the pH can be reduced to a value between 5 and 7. Any suitable acid can be used to reduce the pH of the wastewater solution. One example is acetic acid. Like TBAOH, acetic acid is organic. Thus, the wastewater containing the pH can be reused in a battery recycling process This is because any residues can be removed by sintering, calcining, annealing, and/or otherwise heating the battery material after treatment with the water containing the acetic acid. Further, in some examples, a weak base can be used to reduce a pH of a solution, alternatively to or in addition to an acid.

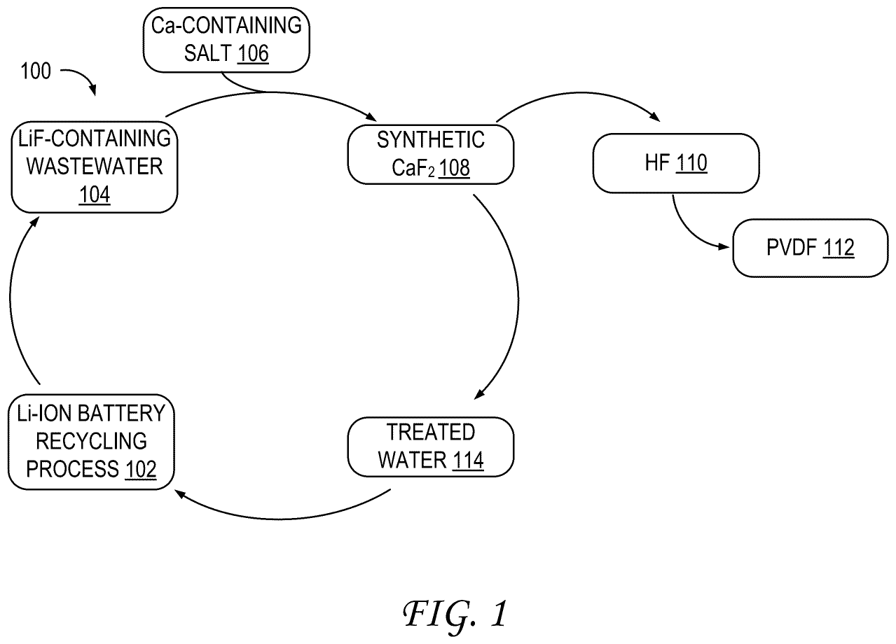

FIG. 1 schematically a process 100 in which capture of fluoride from lithium fluoride-containing wastewater is used to recover useable fluoride and also treat the wastewater for reuse. As described above, various steps in a lithium ion battery recycling process 102 can produce lithium fluoride-containing wastewater 104. Thus, a salt with a cation that forms a relatively insoluble fluoride when added to or exposed to a fluoride-containing solution can be added to the lithium fluoride-containing wastewater 104 to form a synthetic metal fluoride. In FIG. 1, a calcium-containing salt 106 is added to form synthetic calcium fluoride 108. Other example cations that can be added in salt form to form relatively insoluble fluorides include minerals such as hydroxyapatite, bentonite, smectite clay, quicklime, lime, and limestone. In yet further examples, other cations than calcium may be added to wastewater comprising lithium fluoride.

As mentioned above, calcium fluoride is used as an industrial precursor for the manufacture of other fluorine-containing materials. As one example, hydrogen fluoride (HF) can be produced using calcium fluoride, as indicated at 110. HF, in turn, can be used to manufacture other fluorine-containing materials. One example of such a material is shown at 112 as polyvinylidenefluoride, which can be used as a separator in new lithium ion batteries.

Further, as mentioned above, the wastewater after fluoride removal (hereinafter, “treated wastewater”), can be used in battery recycling processes, at 114. When a hydroxide salt, such as calcium hydroxide, is used for fluorine recovery, the resulting lithium hydroxide dissolved in the treated wastewater can be used for multiple steps in a battery recycling process. As one example, the treated wastewater can be used to remove/wash/rinse cathode materials removed from a battery, and particularly nickel-containing materials (such as lithium nickel manganese cobalt oxide). The use of a basic solution, such as a lithium hydroxide solution, for such steps can help to keep the nickel in such materials in a desired oxidation state. Further, the lithium hydroxide also can provide lithium ions for intercalation into the cathode material during later hydrothermal processing, thereby replenishing the cathode material with lithium ions. Additionally, the hydroxide ions can help to decompose binder remaining in the cathode material, thereby producing a more pure cathode material as a product. These processes again introduce fluoride ions into the wastewater, beginning the cycle again at 102.

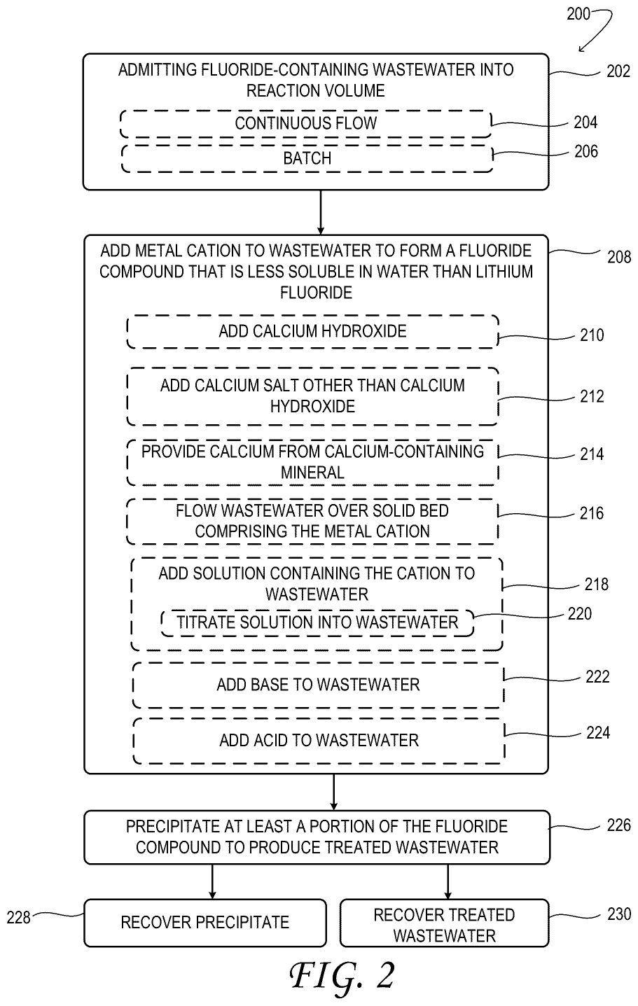

FIG. 2 shows a flow diagram depicting an example method 200 of recovering fluoride from wastewater generated in a battery recycling process. Method 200 comprises, at 202, admitting wastewater into a reaction volume, wherein the wastewater comprises a first, higher concentration of fluoride. In some examples, the wastewater comprises lithium fluoride and is produced in one or battery recycling processes. Examples battery recycling processes that can produce fluoride-containing wastewater include rinsing, separation/binder removal, and hydrothermal processing. In some examples, the wastewater is received in a continuous flow process, as indicated at 204. In other examples, the wastewater is received in a batch process, as indicated at 206.

Continuing, method 200 comprises, at 208, adding a metal cation to the wastewater that reacts with fluoride in the wastewater to form a fluoride compound that is less soluble in water than lithium fluoride. This produces treated wastewater with a second, lower concentration of fluoride. In some examples, the metal cation can be added to the wastewater at ambient temperature. In other examples, the wastewater and the metal cation can be mixed at elevated temperature. Example temperatures include temperatures of between room temperature and 100° C.

One example of a metal cation that can be added to the wastewater as a metal salt is calcium hydroxide, as indicated at 210. The calcium can form aqueous calcium ions that can then react with fluoride ions to form calcium fluoride, which is relatively insoluble in water and thus forms a precipitate. Further, the hydroxide ions in the treated wastewater produced by the precipitation of calcium fluoride can be used in subsequent battery recycling processes, as described above. In other examples, other calcium salts than calcium hydroxide can be used, as indicated at 212. Examples include calcium carbonate and calcium oxide. In some such examples, calcium can be provided by exposing the wastewater to a calcium-containing mineral at 214. Examples of calcium-containing minerals include hydroxyapatite, bentonite, smectite clay, quicklime, lime, and limestone. In yet further examples, other cations than calcium can be added to wastewater comprising lithium fluoride. Examples include aluminum (e.g. aluminum hydroxides), magnesium (e.g. magnesium hydroxides or halides), boron-containing compounds such as boric acid, organoborates, and transition metal hydroxides or halides.

The metal cation can be added to the wastewater in any suitable manner. In some examples, the wastewater can be flowed over a solid bed comprising the metal cation, as indicated at 216. The bed can comprise an excess of a salt (e.g. a mineral) containing the metal cation. The precipitate can deposit in the bed, and thereby be recovered from the bed periodically. In other examples, a solution containing the salt can be added to the wastewater, at 218. In some examples, the salt can be added in stoichiometric excess compared to the lithium fluoride concentration in the wastewater. In other examples, the salt can be titrated into the wastewater, at 220, and a suitable sensor (e.g. a fluoride-selective electrode) can be used to determine an endpoint of the titration. In any of these instances, the salt can be added to the wastewater in a batch or continuous flow process.

As mentioned above, in some examples, method 200 optionally can comprise adding a base to the wastewater, at 222. The base can be used, for example, to adjust a pH of the wastewater. In some examples, the base can comprise an organic base that can be decomposed using one or more of heat or oxygen, for example, in later sintering processes performed on battery cathode material processed using the treated wastewater and/or on the calcium fluoride (or other metal fluoride) recovered from the wastewater by precipitation. Examples of suitable organic bases can include ammonium hydroxide which has a pH of 10, or [ammonium⁺]-[R⁻] where R is the conjugate base of a weak acid such as acetate, lactate, citrate, etc. Ammonium citrate can have a pH ranging from 7.5-9.

A high pH can impede the formation of calcium fluoride, and potentially other metal fluorides. Thus, in some examples where a pH of the wastewater is unsuitably high to form calcium fluoride as a precipitate, method 200 can optionally comprise adding an acid to the wastewater to adjust a pH of the wastewater, at 224. In some examples, the acid can comprise an organic acid that can be decomposed using one or more of heat or oxygen, such as during a subsequent sintering process. Example organic acids include carboxylic acids such as acetic acid, as well as multifunctional acids such as oxalic acid.

Continuing, method 200 comprises, at 226, precipitating at least a portion of the fluoride salt from the wastewater to produce treated wastewater with a second, lower concentration of fluoride than the concentration of fluoride in the original wastewater. As an illustrative example, where the original untreated wastewater comprises a fluoride concentration of approximately 60 ppm, the treated wastewater can comprise a fluoride concentration of approximately 30 ppm. In other examples, untreated wastewater and treated wastewater can have fluoride concentrations other than these illustrative examples.

In some examples, wastewater can include wastewater from aluminum or semiconductor manufacturing. In semiconductor manufacturing, calcium chloride (CaCl₂) can be used to capture fluoride from wastewater containing HF. In aluminum manufacturing, wastewater can contain aluminum trifluoride (AlF₃) in acidic solutions. In some such examples, clay can be used as a fluoride sorbent to reduce the fluoride concentration to an acceptable level for disposal. In both examples disclosed above, the wastewater is acidic, which eases the adsorption/precipitation of fluoride. The system disclosed herein uses feedstock waste solutions comprising a high pH and lithium. Thus, the system disclosed herein aims to recover lithium for use as a feedstock for battery cathode recycling and recover fluoride as CaF₂ for manufacturing.

Method 200 further comprises, at 228, recovering the precipitate, and at 230, recovering the treated wastewater with the second, lower concentration of fluoride. As described above, and as indicated at 240, the treated wastewater can be used for additional battery recycling processes. Further, the precipitate also can be used as a source of fluoride in additional processes. It has been found that recovered calcium fluoride is of relatively high purity, as determined from energy-dispersive X-ray (EDX) and powder x-ray diffraction (XRD) methods.

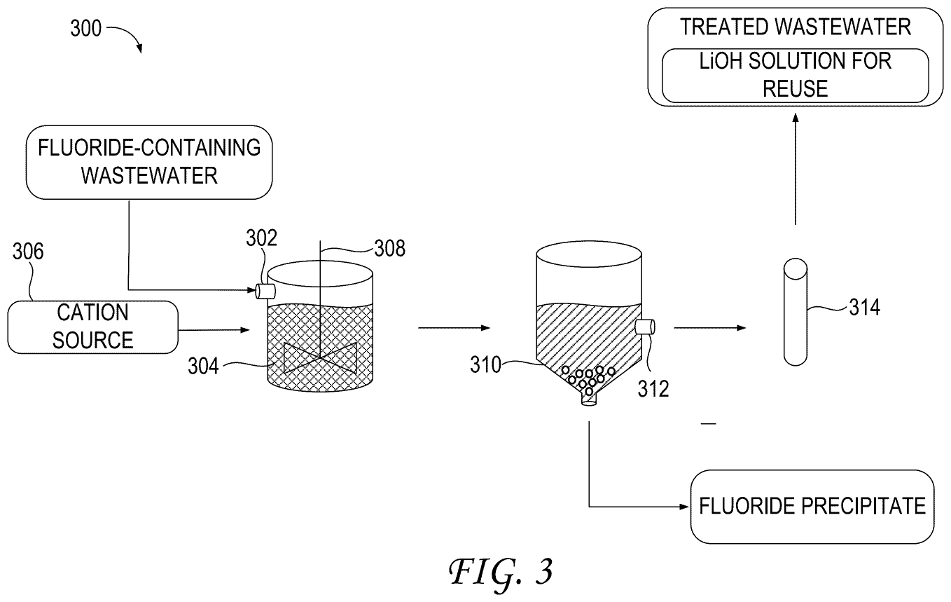

FIG. 3 shows a schematic depiction of a system 300 for treating fluoride-containing wastewater. System 300 comprises an inlet 302 to receive fluoride-containing wastewater. The fluoride-containing wastewater can be produced, for example, in a lithium ion battery recycling process. System 300 further comprises a reaction volume 304. The reaction volume receives the fluoride-containing wastewater from inlet 302, and also receives a cation from a cation source 306. In some examples, the cation source 306 can be a solution-based calcium ion source, such as a dilute calcium hydroxide source. A solution-based cation source can be used to add sufficient cation solution to provide an excess of a metal cation (e.g. calcium 2+), or can be used to titrate the wastewater within the reaction volume 304. Where the cation source 306 is used to titrate the wastewater, a suitable endpoint detecting sensor (e.g. a fluoride-selective electrode) can be included within the reaction volume 304. In other examples, the cation source can comprise a solid bed within the reaction volume 304. The reaction volume can be configured for batch or continuous flow processes. In the depicted example, a mechanical mixer 308 is provided to mix wastewater and solution from the cation source 306. In other examples, other types of mixers can be used. As one example, in a continuous flow system, one or more baffles or other geometric features can be used in a flow path to mix wastewater and cation solution.

The system 300 further comprises a recovery volume 310. The depicted recovery volume 310 comprises a settling tank in which calcium fluoride precipitate (or other suitable fluoride precipitate) can be separated from the wastewater to form treated wastewater. The recovery volume 310 can comprise any suitable separation system. In some examples, the system 300 can comprise a press filter or a centrifuge. In examples where the cation source is a solid bed in the reaction volume, precipitate also can be collected from the solid bed. The system 300 further includes an outlet 312 for treated wastewater. The treated wastewater can be provided, for example, to a calcium ion exchange column 314 to remove excess calcium from the treated wastewater. The resulting treated wastewater, after calcium removal, comprises a lithium hydroxide solution that can be reused in battery recycling processes.

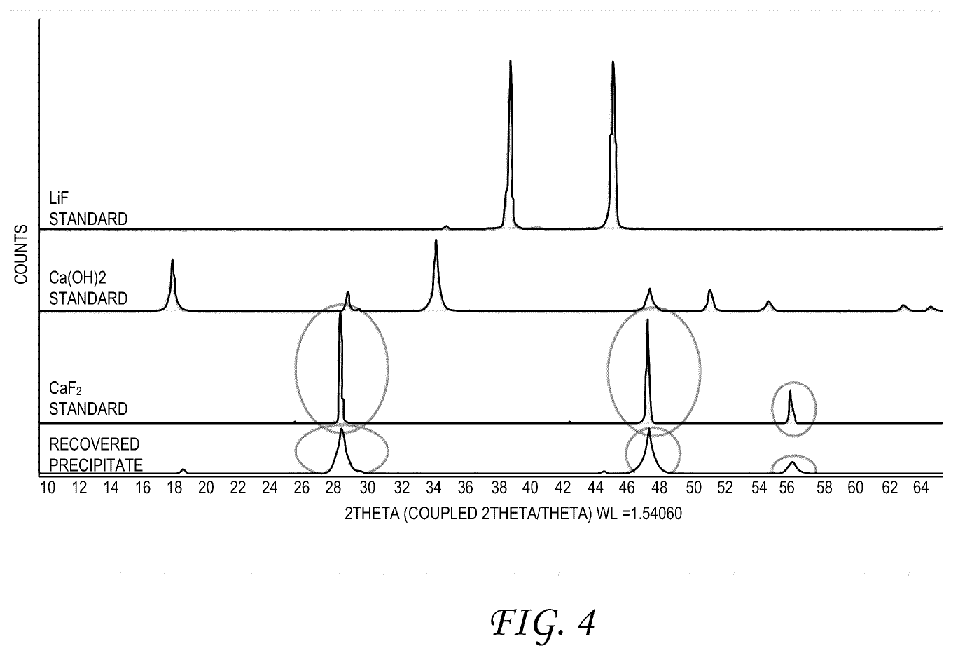

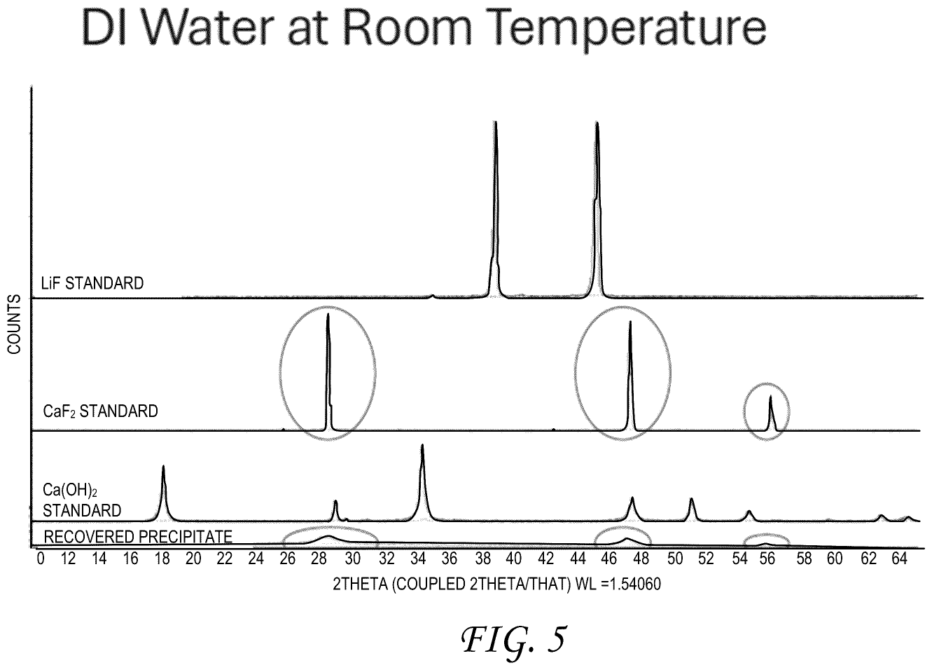

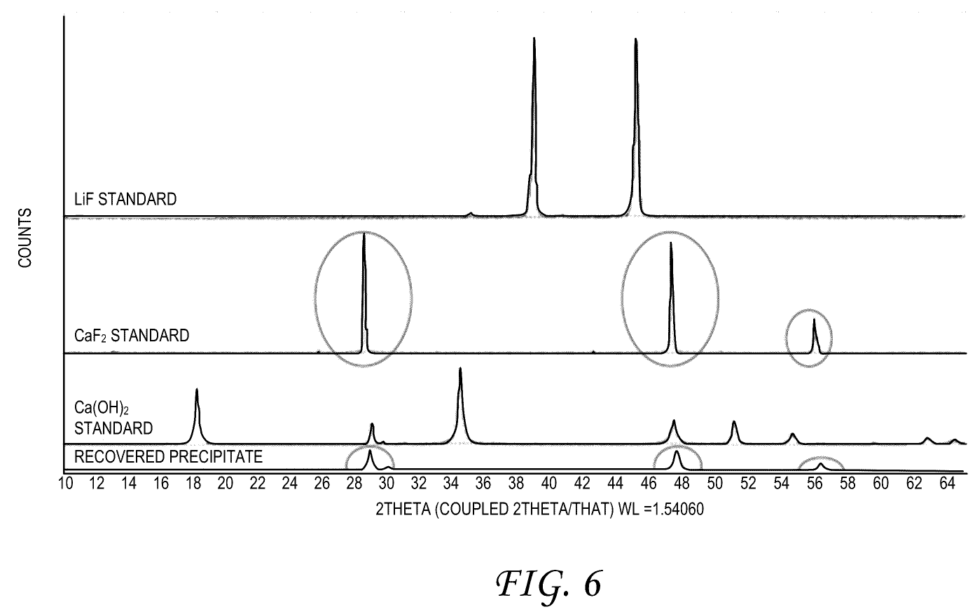

As mentioned above, calcium fluoride recovered from wastewater according to the present disclosure can be of suitable quality for use as a fluoride source for subsequent industrial processes. It has been found via powder x-ray diffraction studies that the precipitate recovered from fluoride-containing wastewater produced in a battery recycling process by following the examples of the present disclosure can be suitably pure calcium fluoride. First, FIGS. 4 and 5 show powder x-ray diffraction scans of precipitate recovered from laboratory-generated experimental lithium fluoride solutions that were mixed using deionized water. The formation of calcium fluoride in the precipitate of the scan of FIG. 4 was caused by mixing calcium hydroxide into the lithium fluoride solution at a temperature of 100 degrees Celsius. The precipitate of the scan of FIG. 5 was formed similarly, but the calcium hydroxide was mixed into the lithium fluoride solution at room temperature. FIG. 6 shows a powder x-ray diffraction scan of precipitate recovered from wastewater from a lithium battery recycling process. The wastewater of FIG. 6 was produced by rinsing a solid lithium nickel manganese cobalt electrode in a lithium hydroxide solution.

Referring first to FIG. 4, the powder x-ray diffraction scan includes standard scans of lithium fluoride, calcium fluoride, and calcium hydroxide. The experimental scan of the recovered precipitate is immediately above the horizontal axis. As can be seen, the single phase contained within the precipitate is calcium fluoride. FIG. 5 also shows that the single phase in the recovered precipitate is calcium fluoride. However, the calcium fluoride of FIG. 5 is less crystalline than that of FIG. 4, as evidenced by the calcium fluoride peak broadening in the scan of precipitate of FIG. 5.

FIG. 6 shows a 2-theta powder x-ray diffraction scan of calcium fluoride recovered from fluoride-containing wastewater from a battery recycling process by adding calcium hydroxide to the wastewater at a temperature below 100 degrees Celsius. Here, it can be seen that the precipitate recovered from the wastewater is single phase calcium fluoride.

In the processes described above, the metal cation acts as a Lewis acid to accept an electron pair from a fluoride ion, thereby forming the relatively insoluble calcium fluoride. In other examples, other Lewis acids can be used to react with fluoride to remove/recover fluoride from a solution comprising lithium fluoride. Other example Lewis acids that can be added to lithium fluoride-containing wastewater to recover fluoride as disclosed include aluminum hydroxide (Al(OH)₃), aluminum hydroxide oxide (AlO(OH)), or alumina polymeric species that may produce AlF₃ or [AlF₄]⁻. AlF₃ may be formed from rinsewaters of battery recycling and may be a source of fluoride for capture by calcium in the process, alumina may be a captured byproduct along with CaF₂. Similarly, transition metal fluorides may also be fluoride sources and their hydroxides may be a captured byproduct.

It will be understood that the configurations and/or approaches described herein are exemplary in nature, and that these specific embodiments or examples are not to be considered in a limiting sense, because numerous variations are possible. This disclosure also includes all novel and non-obvious combinations and sub-combinations of the above articles, systems, configurations, methods, and other features, functions, acts, and/or properties disclosed herein, as well as any and all equivalents thereof.

The specific processes described herein may represent one or more of any number of strategies. Some of the process steps described and/or illustrated herein may, in some embodiments, be omitted without departing from the scope of this disclosure, and/or additional steps may be used. Likewise, the indicated sequence of the process steps may not always be required to achieve the intended results, but is provided for ease of illustration and description. One or more of the illustrated actions, functions, or operations may be performed repeatedly, depending on the particular strategy being used.

1. A method of recovering fluoride from wastewater with a first, higher concentration of fluoride, the method comprising:
adding a metal cation to the wastewater that reacts with fluoride in the wastewater to form a precipitate comprising a fluoride compound that is less soluble in water than lithium fluoride to produce treated wastewater with a second, lower concentration of fluoride; and
recovering the precipitate.

2. The method of claim 1, wherein the metal cation is added as a salt or from a mineral source.

3. The method of claim 1, wherein the metal cation comprises calcium, and the precipitate is calcium fluoride.

4. The method of claim 1, wherein the metal cation comprises one or more of aluminum, magnesium, boron, or a transition metal.

5. The method of claim 1, further comprising adding a base to the wastewater to adjust a pH of the wastewater.

6. The method of claim 5, wherein the base comprises an organic base that can be decomposed using one or more of heat or oxygen.

7. The method of claim 5, wherein the base is a Lewis base that can accept fluoride.

8. The method of claim 1, further comprising adding an acid to the wastewater to adjust a pH of the wastewater.

9. The method of claim 8, wherein the acid comprises an organic acid that can be decomposed using one or more of heat or oxygen.

10. The method of claim 1, wherein the method is performed as a continuous flow process.

11. The method of claim 1, wherein adding the metal cation to the wastewater comprises flowing the wastewater over a solid bed comprising an excess of the metal cation.

12. The method of claim 1, wherein adding the metal cation to the wastewater comprises adding a solution containing the metal cation to the wastewater.

13. The method of claim 12, wherein adding the solution containing the metal cation to the wastewater comprises titrating the wastewater with the solution containing the metal cation.

14. The method of claim 1, further comprising recovering the wastewater with the second, lower concentration of fluoride, and using the wastewater with the second, lower concentration of fluoride in a battery recycling process.

15. The method of claim 14, wherein the wastewater with the second, lower concentration of fluoride comprises lithium hydroxide.

16. A system for recovering fluoride from wastewater with a first, higher concentration of fluoride, the system comprising:
an inlet configured to admit the wastewater;
a reaction volume configured to receive the wastewater from the inlet and contain the wastewater as the wastewater is exposed to a salt, the salt comprising a metal cation that reacts with the fluoride in the wastewater to form a precipitate that is less soluble in water than lithium fluoride; and
an outlet configured to emit treated wastewater with a second, lesser concentration of fluoride.

17. The system of claim 16, wherein the reaction volume is a continuous flow reactor.

18. The system of claim 16, wherein the reaction volume comprises a solid bed containing an excess of the salt.

19. The system of claim 18, wherein the salt comprises a calcium salt.

20. The system of claim 16, further comprising an acid inlet operable to add an acid to the wastewater to adjust a pH of the wastewater.

21. The system of claim 16, further comprising a base inlet operable to add a base to the wastewater to adjust a pH of the wastewater.

22. The system of claim 16, wherein the outlet is connected to an inlet of a reactor used in a battery recycling system.
